(19) United States
(12) Patent Application Publication
(10) Pub. No.: US 2006/0123725 A1
(43) Pub. Date: Jun. 15, 2006

(54) Modular composite wall panel and method of making the same

(75) Inventor: L. Grant Godwin, Raleigh, NC (US)

Correspondence Address: BARNES & THORNBURG, 11 SOUTH MERIDIAN, INDIANAPOLIS, IN, 46204, US

(73) Assignee: Martin Marietta Materials, Inc.

(21) Appl. No.: 11/299,887

(22) Filed: Dec. 12, 2005

Related U.S. Application Data
(60) Provisional application No. 60/636,186, filed on Dec. 15, 2004.

(51) Int. Cl. B32B 7/00

(52) U.S. Cl. 52/309.11; 428/119

(57) ABSTRACT

A composite panel comprises composite first and second sheets, a core sandwiched between the first and second sheets, a plurality of fiber insertions extending from the first sheet through the core to the second sheet, and a utility space defined in the core between a number of the fiber insertions. A method of making the composite panel is disclosed.

### CROSS-REFERENCE

This application claims the benefit under 35 U.S.C. § 119(e) of U.S. Provisional Patent Application No. 60/636,186 which was filed Dec. 15, 2004 and is hereby incorporated by reference herein.

### TECHNICAL FIELD

The present disclosure relates generally to composite panels for use in the construction of structures such as buildings and vehicles.

### BACKGROUND

Panels are used in the construction of a variety of structures. They may be used, for example, in the construction of building, vehicles, and any number of other facilities and structures.

### SUMMARY

A composite panel comprises composite first and second sheets, a core sandwiched between the first and second sheets, a plurality of fiber insertions extending from the first sheet through the core to the second sheet, and a utility space defined in the core between a number of the fiber insertions for utilities. A method of making the composite panel is disclosed.

Illustratively, the composite panel may be used as a wall panel, a floor panel, or a ceiling panel. The composite panel may be a continuously formed panel. The composite panel may be formed in finished form.

The composite panel may be configured for modular construction. The panel may be embodied as a relatively lightweight panel. The panel may be embodied as an insulated panel. The composite panel may be configured to be aesthetically pleasing. The composite panel may be configured to be removably connected to another panel.

The composite panel may be used in the construction of a stationary structure such as a building. The composite panel may also be used in the construction of a mobile structure such as a recreational vehicle.

The above and other features of the present disclosure will become apparent from the following description and the attached drawings.

### BRIEF DESCRIPTION OF THE DRAWINGS

FIG. 1 is a fragmentary, diagrammatic cross sectional view of a composite wall panel;

FIG. 2 is a view similar to FIG. 1, but showing a cavity formed in the composite wall panel;

FIGS. 3a and 3b are perspective views of the composite wall panel of FIG. 1;

FIGS. 4a and 4b are perspective views of two composite wall panels connected to one another;

FIG. 5 is a perspective view of a corner connector;

FIG. 6 is a perspective view showing the composite wall panels having composite floor panels and composite ceiling panels connected thereto; and

FIGS. 7a, 7b, and 7c are fragmentary side elevational views showing two wall panels connected to one another in various ways.

### DETAILED DESCRIPTION OF ILLUSTRATIVE EMBODIMENTS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

The present disclosure relates to a composite panel for use in the construction of walls or wall sections. In one exemplary embodiment, the composite panel includes a core, and two face sheets secured to the core. An outer cover may be secured to each of the face sheets or integrated therewith. Such a composite panel may be fabricated in a continuous manner. In one specific implementation, the composite panel may be formed with passageways, cavities, openings, or other utility spaces or features for utilities in the panel before the panel is cured. In another specific implementation, a CNC machine may be used to machine such passageways, cavities, openings, or other utility spaces or features for utilities after the panel has been formed.

One exemplary type of composite panel is an FRP (fiber-reinforced polymer) panel. Such an FRP panel may be formed of a polymer matrix composite material which includes a reinforcing agent and a polymer resin. The FRP panel may be embodied as any type of FRP structure. Examples of such structures include, but are not limited to, a solid laminate; a sandwich panel having, for example, upper and lower skins (sheets) with a core therebetween; or a panel having, for example, upper and lower skins (sheets) with vertical or diagonal webs therebetween. Such structures may be, for example, pultruded or vacuum-infused.

The matrix may include a thermosetting resin, although thermoplastic resins are also contemplated for use. Examples of thermosetting resins which may be used include, but are not limited to, unsaturated polyesters, vinyl esters, polyurethanes, epoxies, phenolics, and mixtures and blends thereof.

The reinforcing agent may include E-glass fibers, although other reinforcements such as S-glass, carbon, kevlar, metal, high modulus organic fibers (e.g. aromatic polyamides, polybenzamidazoles, and aromatic polyimides), and other organic fibers (e.g. polyethylene and nylon) may be used. Blends and hybrids of the various reinforcing materials may be used. Other suitable composite materials may be utilized including fibers such as boron, aluminum silicate, and basalt. The reinforcing agent may take the form of one or more fabrics.

In the case of where the FRP panel is embodied as a sandwich panel, the core type may include, but is not limited to, balsa wood, foam and various types of honeycomb. Each skin (sheet) may take the form of a solid laminate having a plurality of textile plies laminated together.

The FRP panel may be embodied as any of the structures disclosed in U.S. Pat. Nos. 5,794,402; 6,023,806; 6,044,607; 6,070,378; 6,081,955; 6,108,998; 6,467,118 B2; 6,645,333; 6,676,785, the entirety of each of which is hereby incorporated by reference. It should be appreciated that the structures disclosed in the above-identified patents may be sized, scaled, dimensioned, orientated, or otherwise configured in any desired manner to fit the needs of a given design of the FRP panel.

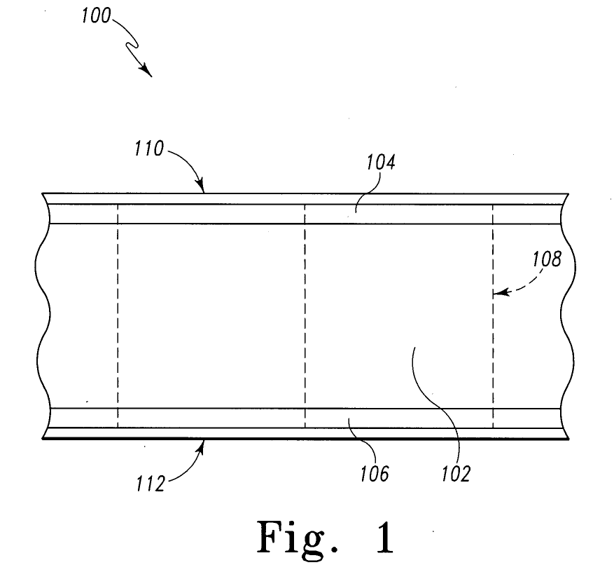

A specific exemplary embodiment of a composite wall panel 100 is shown in FIG. 1. The wall panel 100 includes a core 102 having a number of structure members. The structure members may take the form of tubes of virtually any geometric shape, including “I” or “C” shapes, or a variety of forms including tubes or waves or even a solid block or combinations thereof. The structure members may be configured to fit the needs of a given design or application. The core 102 also includes insulation material. The insulation material of the core 102 may be configured to provide a desired R-value to fit the needs of a given design or application.

The core 102 is sandwiched between a pair of face sheets 104, 106. During the panel fabrication process, a number of unstable fibers (fiber insertions) 108 may be inserted through the dry sandwich defined by the core 102 and the face sheets 104, 106 with the ends of the unstable fibers 108 pultruding through on both sides of the face sheets 104, 106. Subsequently, resin is injected onto the exposed ends of the unstable fibers 108, and the ends of the fibers 108 are folded back by the die thereby integrating the ends of the fibers 108 into the face sheets 104, 106.

One or more covers 110, 112 may be secured to the face sheets 104, 106 of the wall panel 100. The covers 110, 112 may be embodied as any one or more of a variety of gels or other coating materials that provide, for example, weather protection and/or camouflage. The cover 110, 112 may also be embodied as other types of materials such as metal sheets. The type of cover may vary on each panel, and may vary between panels. Moreover, different types of covers may be used to cover the exterior or interior surfaces of the wall panel 100. For example, an exterior cover may be finished in a predetermined, desired exterior color, a brick facade, or even a camouflaged pattern. Similarly, interior covers may be finished in an interior painted surface appearance, a wood-grain surface, or any other desired surface finish. The covers 110, 112, the face sheets 104, 106, and the core 102 may be co-cured with one another.

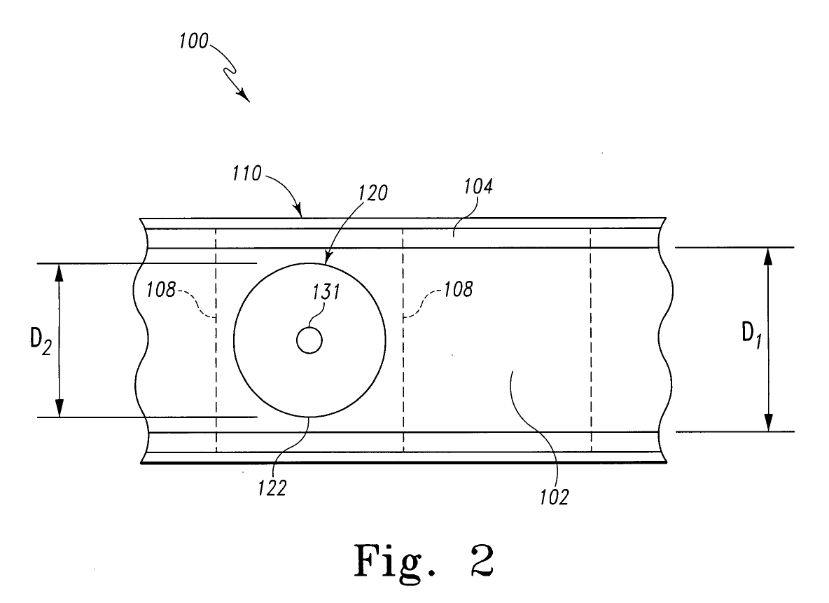

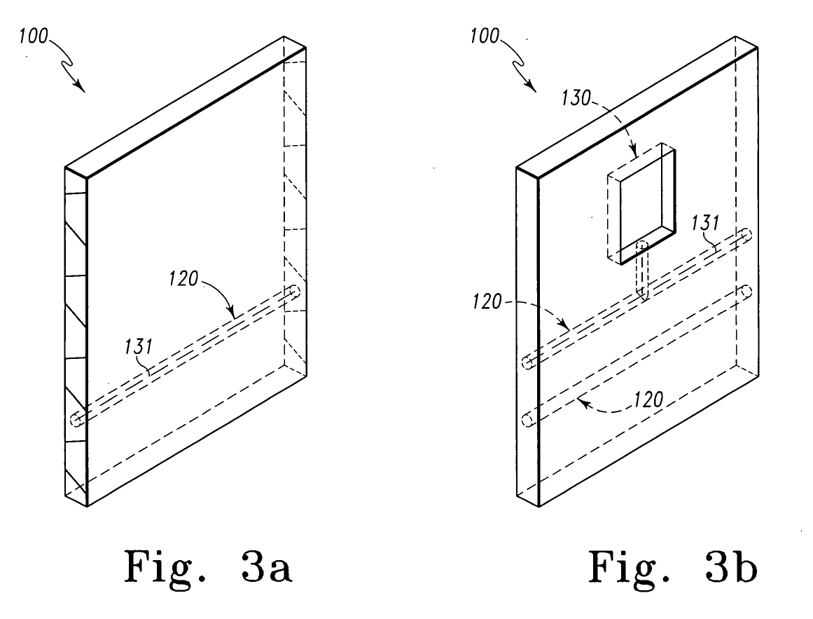

Referring now to FIGS. 2 and 3, at least one cavity or other utility space 120 may be formed in the composite wall panel 100 in the core 102 between a number of the fibers 108. The cavity 120 may extend from one edge of the wall panel 100 to another edge of the wall panel 100, as shown in FIG. 3a. As shown in FIG. 3b, a wall panel 100 may be configured to include more than one cavity 120.

The cavity 120 may be formed in a variety of ways. One method of forming the cavity 120 in the wall panel 100 is to drill the cavity 120 into the wall panel 100. The cavity 120 may also be formed as part of the continuous panel fabrication process.

The cavity 120 may also be formed by inserting a form 122 in the core 102. The form 122 may be embodied as a round tube. A square or other geometrically- or irregularly-shaped form 122 may be used as well. The width (D2) of the form 122 is smaller than the thickness (D1) of core 102. The thickness of the cavity 102 corresponds to the width of the form 122. As such, the thickness of the cavity 120 is smaller than the thickness of the core 102.

Other types of cavities may be formed in a similar manner. For example, a utility box 130 may be inserted into the core 120. If need be, access to the utility box may be achieved with a jig saw cut. However, if the utility box is unneeded, the cover 110, 112 may be used to conceal the utility box until it is needed. If the utility box 130 is exposed, a conventional switch plate or other cover may be used to cover the box's opening. It should be appreciated that more than one utility box 130 may be used per panel.

Materials having different melting points may be used to form a highly complex internal cavity. For example, when two materials having different melting points are used, the material with the higher melting point may be used to drain the material with the lower melting point from the panel 100 upon melting of the material with the lower melting point. In this way, a cavity having a desired shape may be produced.

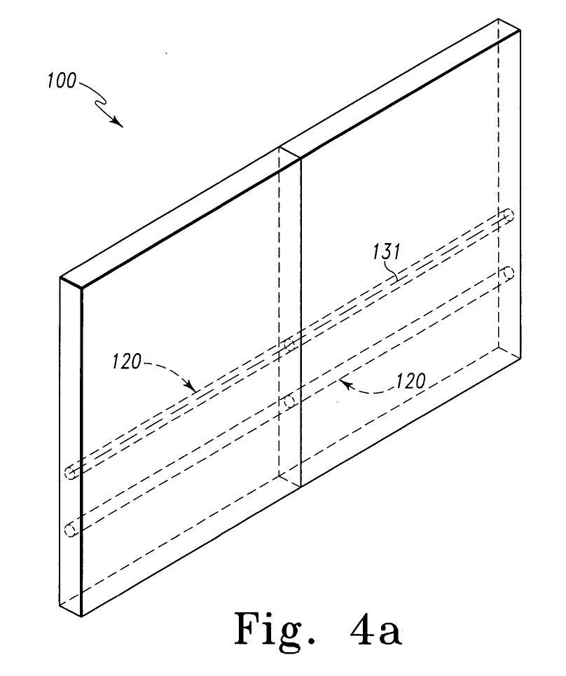

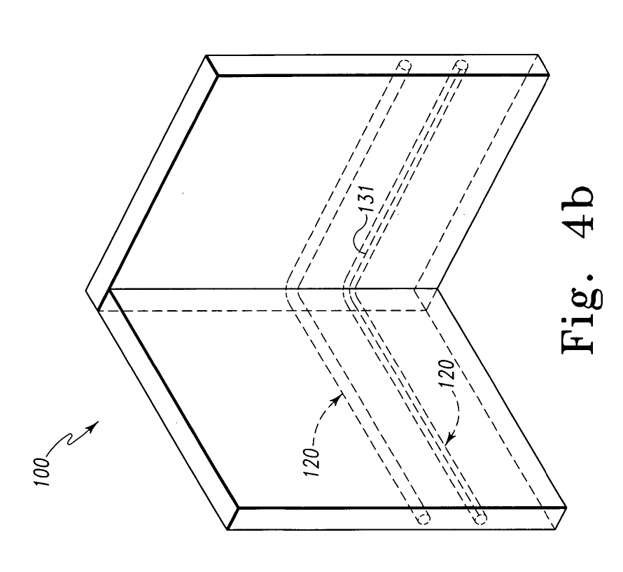

As shown in FIGS. 4a and 4b, two or more of the wall panels 100 may be connected together. In FIG. 4a, two of the wall panels 100 are arranged so that the wall panels 100 form a straight wall (or a portion of a straight wall). As shown in FIG. 4b, the wall panels 100 may also be arranged so that the panels 100 form a wall corner. In both cases, the cavities 120 in the two wall panels 100 are aligned so that the cavities 120 of one wall panel communicate with the cavities 120 of the adjoining panel 100.

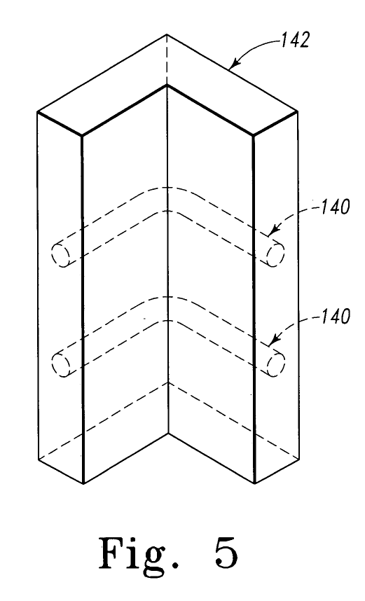

As shown in FIG. 5, a corner connector 142 may be designed with a pair of cavities 140 formed therein. A wall panel 100 may be coupled to each edge of the connector 142. In such a case, the cavities 140 of the corner connector 142 align with the cavities 120 of the wall panels 100. The cavities 140 may be configured to allow for the insertion of PVC pipe (or other rigid/semi-rigid objects) to facilitate connections through the corner. Other shapes for facilitating other types of connections, including T-shaped and X-shaped connections, are also contemplated. It is within the scope of this disclosure for adjacent wall panels 100 to be secured to one another by heat welding.

The cavities 120 formed in the wall panels 100 and the cavities 140 formed in the corner connector 142 may be dimensioned to accommodate any type of utility. For example, the cavities 120, 140 may be configured to accommodate, amongst numerous other things, utility lines 131 routed therethrough. Such utility lines 131 may include, but are not limited to, telephone lines, data lines, audio/video lines, water lines, gas lines, waste/drainage lines, and power lines. The number, type, and size of the cavities formed in the panel 100 may be determined based on, for example, the usage of the structure (e.g., room) fabricated from the panels 100. Moreover, unused cavities may be formed in a wall panel 100 for future expansion. It is also contemplated to have one or more of the panels 100 connected to another panel in a manner in which at least one of the cavities one of the panels is not aligned with another cavity in the other panel.

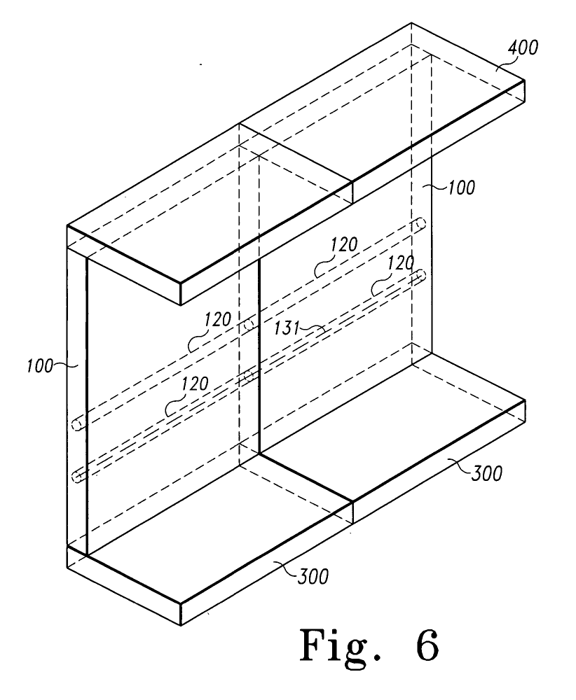

As shown in FIG. 6, a number of composite floor panels 300 similar in design to the wall panels 100 may be connected to the wall panels 100. Similarly designed ceiling panels 400 may also be connected to the wall panels 100. The ceiling panels 400 may be formed to include hanger connectors. As such, any of the floor panels 300 and ceiling panels 400 may include one or more cavities 120 formed in the core 102 between fiber insertions 108 for utilities to be routed through the cavities 120.

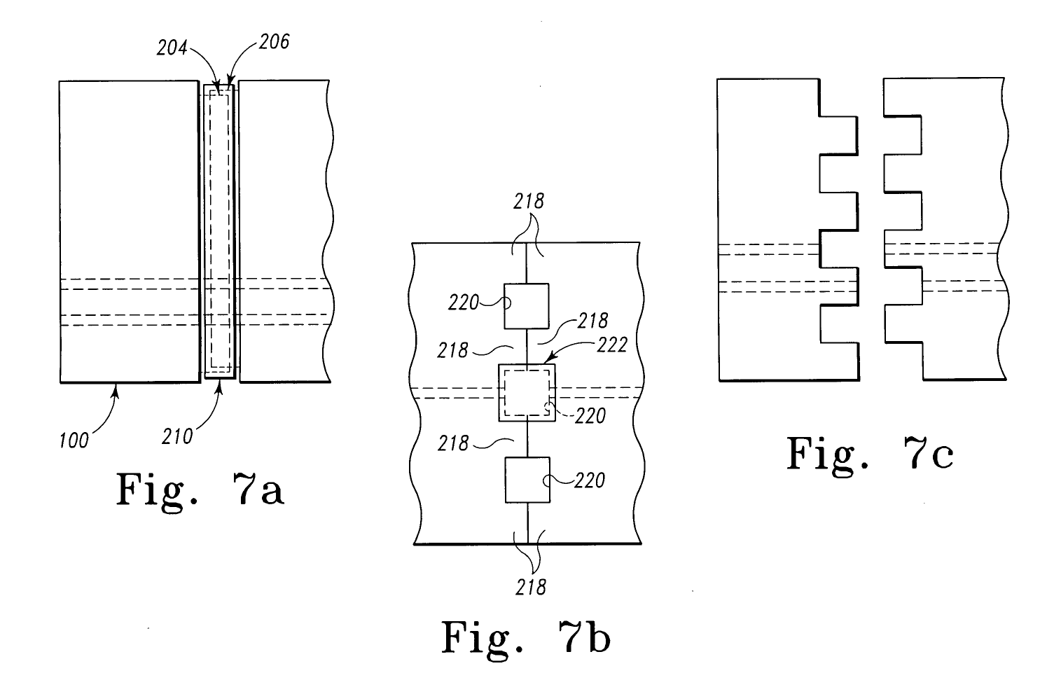

Referring now to FIGS. 7a, 7b, and 7c, a number of connection arrangements for connecting adjacent panels 100 are shown. As shown in FIG. 7a, a pair of wall panels 100 may be connected together by use of one or more tabs 204, 206. The tabs 204, 206 may be formed in the panels 100 during the continuous panel fabrication process or may be secured to the panels 100 after the panels are formed. The tabs 204, 206 facilitate access to utility lines within the walls formed by the panels 100. In order to preserve the aesthetics of the panels 100, a cover 210 may be placed thereon. The cover 210 may be configured to match the covers 110, 112 on the wall panels 100.

As shown in FIG. 7b, a plurality of tabs 218 may be formed in each panel 100. The tabs 218 may be aligned with the tabs 218 from an adjacent panel to define an access opening 220 to allow access to utilities formed in the cavities. The openings 220 may be covered with cover 222 or a conventional socket or switch cover as needed.

As shown in FIG. 7c, the panels 100 may be configured to connect to an adjacent panel 100 by use of a dovetail joint or other interlocking joint.

Any of the panels disclosed herein may be reinforced in the vicinity of the cavities 120 formed therein. For example, the insertion density of the fibers 108 may be non-uniform. In particular, the insertion density of the fibers 108 may be greater near the cavities 120 than away from the cavities 120 such that there are more fibers 108 per unit area near the cavities 120 than away from the cavities 120, thereby providing additional support for the cavities 120. It is also possible to configure the core 102 so as to have a non-uniform density. For example, the core 102 may include a first portion having a first density (e.g., foam having density of 2 pounds/area) and a second portion having a greater second density (e.g., foam having density of about 4 pounds/area). In some examples, the second portion of the core 102 may be provided about the cavities 120 for additional support.

While the concepts of the present disclosure have been illustrated and described in detail in the drawings and foregoing description, such illustration and description is to be considered as exemplary and not restrictive in character, it being understood that only illustrative embodiments have been shown and described and that all changes and modifications that come within the spirit of the disclosure are desired to be protected.

There are a plurality of advantages of the concepts of the present disclosure arising from the various features of the systems described herein. It will be noted that alternative embodiments of each of the systems of the present disclosure may not include all of the features described yet still benefit from at least some of the advantages of such features. Those of ordinary skill in the art may readily devise their own implementations of a system that incorporate one or more of the features of the present disclosure and fall within the spirit and scope of the invention as defined by the appended claims.

1. A composite panel comprising composite first and second sheets, a core sandwiched between the first and second sheets, a plurality of fiber insertions extending from the first sheet through the core to the second sheet, and a utility space defined in the core between a number of the fiber insertions.

2. The composite panel of claim 1, further comprising a utility line routed through the utility space.

3. The composite panel of claim 1, further comprising first and second edges, wherein the utility space extends from the first edge to the second edge.

4. The composite panel of claim 1, wherein the core has a thickness, and the utility space has a thickness smaller than the thickness of the core.

5. The composite panel of claim 1, further comprising a utility box mounted in the core and communicating with the utility space.

6. The composite panel of claim 1, further comprising another utility space defined in the core between a number of the fiber insertions.

7. The composite panel of claim 1, wherein the composite panel is a wall panel.

8. The composite panel of claim 1, wherein the composite panel is a floor panel.

9. The composite panel of claim 1, wherein the composite panel is a ceiling panel.

10. A panel assembly comprising first and second composite panels, each of the first and second composite panels comprising fiber-reinforced polymer first and second sheets, a core sandwiched between the first and second sheets, a plurality of fiber insertions extending from the first sheet through the core to the second sheet, and a utility space defined in the core between a number of the fiber insertions, wherein the first and second composite panels are secured to one another such that the utility spaces thereof are in communication with one another.

11. The panel assembly of claim 10, further comprising a utility line routed through the utility spaces of the first and second composite panels.

12. The panel assembly of claim 10, wherein the first and second composite panels cooperate to provide a straight portion of a wall, ceiling, or floor.

13. The panel assembly of claim 10, wherein the first and second composite panels are angled relative to one another such that the first and second composite panels cooperate to provide a corner.

14. The panel assembly of claim 10, further comprising a corner connector secured to an edge of the first composite panel and an edge of the second composite panel and located between the first and second composite panels to define a corner therebetween, wherein the corner connector defines a utility space in communication with the utility spaces of the first and second composite panels.

15. The panel assembly of claim 10, wherein:
the first composite panel comprises at least one tab, and
the second composite panel comprises at least one tab that cooperates with the at least one tab of the first composite panel to align the utility spaces.

16. The panel assembly of claim 15, wherein:
each of the at least one tab of the first composite panel and the second composite panel comprises a plurality of spaced-apart tabs, and
each tab of the first composite panel is aligned with a corresponding tab of the second composite panel such that an access opening is defined between tabs of the first and second composite panels, the access opening in communication with the utility spaces.

17. The panel assembly of claim 15, wherein:
each of the at least one tab of the first composite panel and the second composite panel comprises a plurality of spaced-apart tabs, and
the plurality of spaced-apart tabs of the first composite panel interlock with the plurality of spaced-apart tabs of the second composite panel to align the utility spaces.

18. A method of making a composite panel, comprising the step of forming a utility space between fiber insertions extending from a composite first sheet to a composite second sheet through a core sandwiched between the first sheet and the second sheet.

19. The method of claim 18, further comprising routing a utility line through the utility space.

20. The method of claim 18, wherein the forming step comprises extending the utility space from a first edge of the composite panel to a second edge of the composite panel.
